(19) United States
(12) Patent Application Publication
(10) Pub. No.: US 2014/0229194 A1
(43) Pub. Date: Aug. 14, 2014

(54) VIRTUAL HEALTH INSURANCE CARD SYSTEMS AND METHODS

(71) Applicant: Medlio, Inc., Durham, NC (US)

(72) Inventor: David S. Brooks, Durham, NC (US)

(73) Assignee: Medlio, Inc., Durham, NC (US)

(21) Appl. No.: 14/180,261

(22) Filed: Feb. 13, 2014

Related U.S. Application Data
(60) Provisional application No. 61/764,432, filed on Feb. 13, 2013.

(51) Int. Cl. G06Q 40/08; G06Q 50/22

(52) U.S. Cl. CPC G06Q 40/08; G06Q 50/22
USPC 705/2

(57) ABSTRACT

A machine-controlled method can include a mobile electronic device capturing an image of a physical health insurance card for a healthcare plan for a user, retrieving health insurance information corresponding to the healthcare plan for the user, and a datastore storing a virtual health insurance card for the user, the virtual health insurance card including the health insurance information.

### CROSS-REFERENCE TO RELATED APPLICATION

This application claims the benefit of U.S. Provisional Patent Application Ser. No. 61/764,432, titled “VIRTUAL HEALTH INSURANCE CARD SYSTEMS AND METHODS” and filed on Feb. 13, 2013, the content of which is hereby incorporated herein by reference in its entirety.

### TECHNICAL FIELD

The disclosed technology pertains generally to the healthcare industry and, more particularly, to systems and methods pertaining to virtual health insurance cards.

### BACKGROUND

Currently, when a patient sees a healthcare provider for the first time, the provider's office must obtain insurance information, demographic information, and medical history information from the patient. This typically involves the patient providing his or her physical insurance card, as well as taking as much as 10-15 minutes or more to complete registration materials as well as one or more medical history forms. Because of the difficulty in confirming insurance information at the time of check-in, many offices simply assume that the card is accurate and current and then manually type the patient's insurance information into an electronic medical record (EMR) and/or the office's practice management (PM) system, and then photocopy the patient's insurance card.

For established patients, the healthcare provider's front office must validate that all insurance and demographic information they currently possess on the patient is accurate and up to date. To do this, the front office staff must ask each patient if any information has changed since the patient's last visit. This validation process is unreliable, as patients themselves are frequently unaware when their insurance information has changed or the exact nature of the information currently held in the provider's system. Typically, to avoid filling out additional forms, patients will indicate that nothing has changed.

If a patient has a PPO plan with clearly stated copay responsibilities (a rapidly declining likeliness), the healthcare provider's front office will typically collect amounts as specified on the patient's insurance card. In the event of coinsurance and/or high deductible plans, provider offices will frequently collect nothing before the visit, see the patient, and then submit a claim to the patient's insurance company. Once the patient's insurance company adjudicates the claim, which generally takes about one week if submitted promptly, the office will get a clear indication of how much the office should charge the patient. At this point, the office will begin sending patient statements to patients in order to attempt collection.

However, patients are typically poor payers. This is likely caused by a combination of many factors, including a general perception that healthcare is a universal entitlement and that failing to pay medical bills will not affect a patient's credit history. Regardless, anywhere from 30 to 40 percent (or more) of total patient bills will never be paid. And, those that are paid typically take 3 to 6 months, if not longer, which wreaks havoc on the provider's cashflow. As the percentage of payment responsibility shifts from insurance companies to patients (some estimates place total patient responsibility at 35% of total medical bill), this places substantial pressure on provider organizations to improve the patient collection process.

The first step towards minimizing the patient collection quagmire is to perform eligibility verification. There are at least two ways that providers can currently verify a patient's insurance eligibility. First, the provider can log into the patients' insurance companies' web portals and conduct a benefits lookup for each patient seen. This is usually problematic, however, because it typically requires logging into multiple separate insurance portals, which is time consuming, inefficient, and frequently difficult to interpret the correct benefit based on the specific service being provided. Another option is to use a clearinghouse service for certain transactions, e.g., ANSI X12 270/271 transactions. This information is typically not well integrated into existing systems and, with less than 50% of providers using EMRs, is still not widespread. For those who have the ability to support 270/271 transactions, many view this as yet another clearinghouse fee that they are reluctant to pay.

Eligibility verification will only tell providers if they have the current insurance information needed to submit a claim, whether the patient's insurance is currently active, specific copayment amounts, whether the patient has a deductible and, if so, how much has been satisfied to date, and then the co-insurance percentage a patient is responsible for once the deductible has been satisfied. This information is valuable but—other than in the case of copay plans—does not tell a provider specifically how much to collect from the patient prior to the visit. As a result, even with eligibility verification, most offices will defer collection until the claim has been processed by insurance. With more and more employers (e.g., group plans) and self-insured patients moving to high deductible plans, this means that, as overall patient responsibility increases, the amount being collected prior to visits is actually declining.

Thus, there remains a need for a way to address these and other problems associated with the prior art.

### BRIEF DESCRIPTION OF THE DRAWINGS

FIG. 1 illustrates an example of a virtual health card architecture in accordance with certain embodiments of the disclosed technology.

FIG. 2 is a flow diagram illustrating an example of a patient-centric process flow in accordance with certain embodiments of the disclosed technology.

FIG. 3 is a flow diagram illustrating an example of a provider-centric process flow in accordance with certain embodiments of the disclosed technology.

FIG. 4 is a flow diagram illustrating an example of an estimator-centric process flow in accordance with certain embodiments of the disclosed technology.

FIG. 5 is a flowchart illustrating an example of a one-time authorization process flow in accordance with certain embodiments of the disclosed technology.

### DETAILED DESCRIPTION

Certain embodiments of the disclosed technology are directed to a virtual insurance identification card, e.g., a health insurance card in a smartphone application, that may advantageously enable healthcare cost transparency for both patients and providers. Such a virtual card may provide end-users with current, up-to-date health benefits information as well as a centralized location for creating, storing, and sharing medical forms data. As described below, the disclosed smart insurance card systems and methods may provide any of a number of valuable benefits to the three major stakeholders in the healthcare ecosystem: providers, patients, and payers.

Implementations of the disclosed technology may advantageously give providers the ability to conduct real-time eligibility verification on nearly all patients, regardless of insurance provider (indeed, only the smallest insurance companies and third party administrators currently do not support 270/271 transactions). Real-time eligibility verification, when combined with an understanding of carrier-specific reimbursement schedules and the reason for office visit, can be used to accurately estimate the cost of healthcare transactions before they occur. With the dramatic shift in financial responsibility from insurance to consumers, this benefit alone is expected to be so significant that providers will strongly encourage patients to use certain aspects of the disclosed technology. Patients who use implementations of the disclosed technology will typically no longer need to carry around a physical insurance card. Instead of carrying physical cards that effectively become outdated the moment they are printed, patients may now carry an electronic version of their insurance card that is generally accurate and kept up-to-date. A benefit for patients is that they will have real-time health insurance benefits information as well as health insurance terms and exclusions. This means they will know copays they should expect to pay, and in the increasing case of high deductible health plans (HDHPs), will be able to check status on deductible progress. With HDHPs patients are thinking more like traditional consumers and want access to and transparency around pricing information.

An additional benefit for patients is form functionality. Certain implementations of the disclosed technology may advantageously expand the functionality of a smart health insurance card to include medical history forms. Patients may fill out medical forms once, in a mobile application, for example, and then use that for all future medical and dental visits/purposes. Forms often create anxiety for patients who have myriad medications, complicated health histories as well as caretakers who have multiple children and therefore need to fill out multiple redundant forms. Embodiments of the disclosed technology may support a standard, base-level set of forms data necessary to satisfy most health providers.

When patients check-in to the office or facility, a provider portal may notify the office or facility that the patient's information is available for secure viewing. In the event the office or facility is not already registered, the patient can send an email to the office or facility that will redirect the provider to a secure location within a web application where forms data can be accessed. If providers require more information than is supported in the base-forms, they can create additional data fields within the provider portal. At the time of check-in, if the office requires additional fields, the patient's application may receive an alert asking them to complete the additional form fields on their smartphone. Once entered, these additional fields are added to the patient's permanent profile.

Because forms can present problems and are perceived as such a headache for patients, we expect that this benefit alone is so great that patients will strongly encourage their providers to use at least certain aspects of the disclosed technology.

Implementations of the disclosed technology may advantageously eliminate the need for payers to produce and ship physical, e.g., plastic, wallet insurance cards. Embodiments of the disclosed technology may also provide payers a potential communications portal to patients, thus eliminating the need to print and ship EOBs (explanation of benefits)—which can be sent using an electronic system instead. This may also provide a channel to communicate offers to patients to seek preventative care and to identify gaps in care and communicate such to the patient. Payers have repeatedly—and unsuccessfully—tried to connect with patients. Because implementations of the disclosed technology will likely gain traction among insurance companies' customer-bases, such will likely be viewed as a highly valuable patient-engagement platform by said insurance companies.

Because the cost savings for payers can be significant, it is likely that payers will strongly encourage and possibly incentivize patients and their providers to make use of certain aspects or implementations of the disclosed technology.

The symbiotic nature of bringing providers, patients, and payers together in such a mutually beneficial way may serve as the beginning of a communications hub (e.g., a communications connection) between the three parties. Implementations of the disclosed technology may break down barriers between providers, patients, and payers, and the provider and payer may effectively seem to function as one entity from the perspective of the patient.

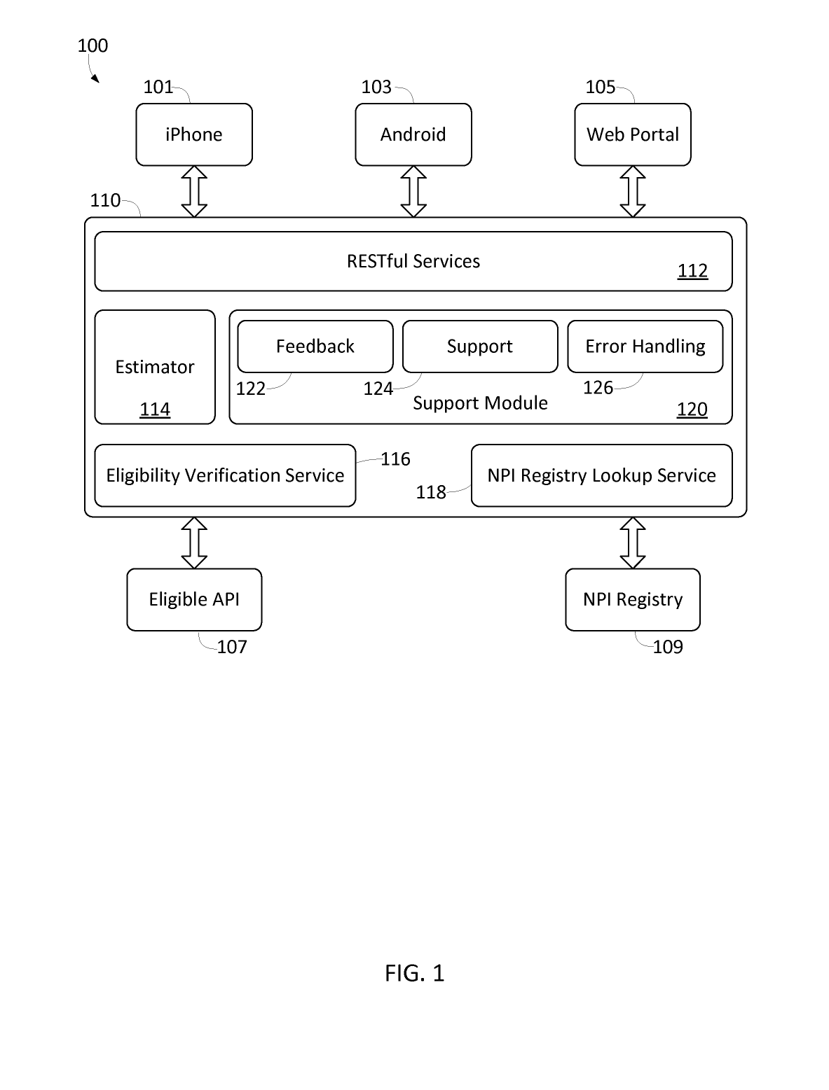

FIG. 1 illustrates an example of a virtual health card architecture 100 in accordance with certain embodiments of the disclosed technology. In the example, the virtual health card architecture 100 includes a central system 110 configured to communicate with any of a number of various types of electronic devices such smartphone devices (e.g., an iPhone 101 and/or an Android-based phone 103), other mobile electronic devices such as tablet computing devices, a web-based portal 105, or any combination thereof.

The central system 110 generally includes RESTful (i.e., Representational State Transfer-based) web services 112, an estimator 114, an eligibility verification service 116 configured to communicate with or otherwise interact with an eligible application programming interface (API) 107, and a national provider identifier (NPI) registry lookup service 118 configured to communicate with or otherwise interact with an NPI registry 109. In the example, the virtual health card architecture 100 also includes a support module 120 that includes a feedback component 122, a support component 124, and an error handling component 126.

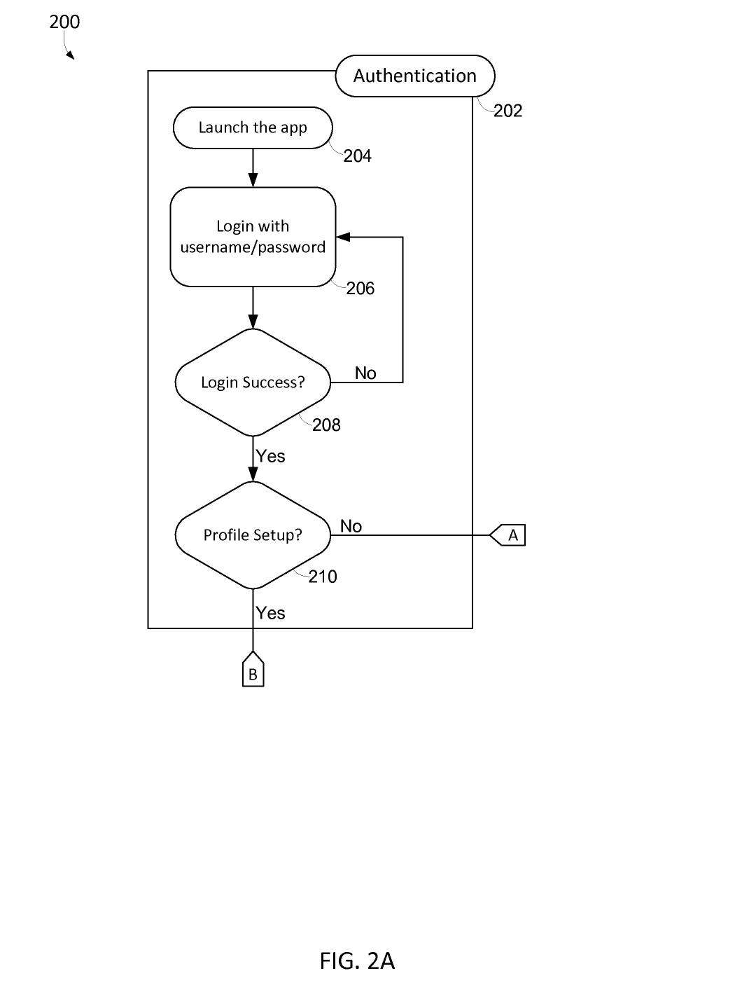

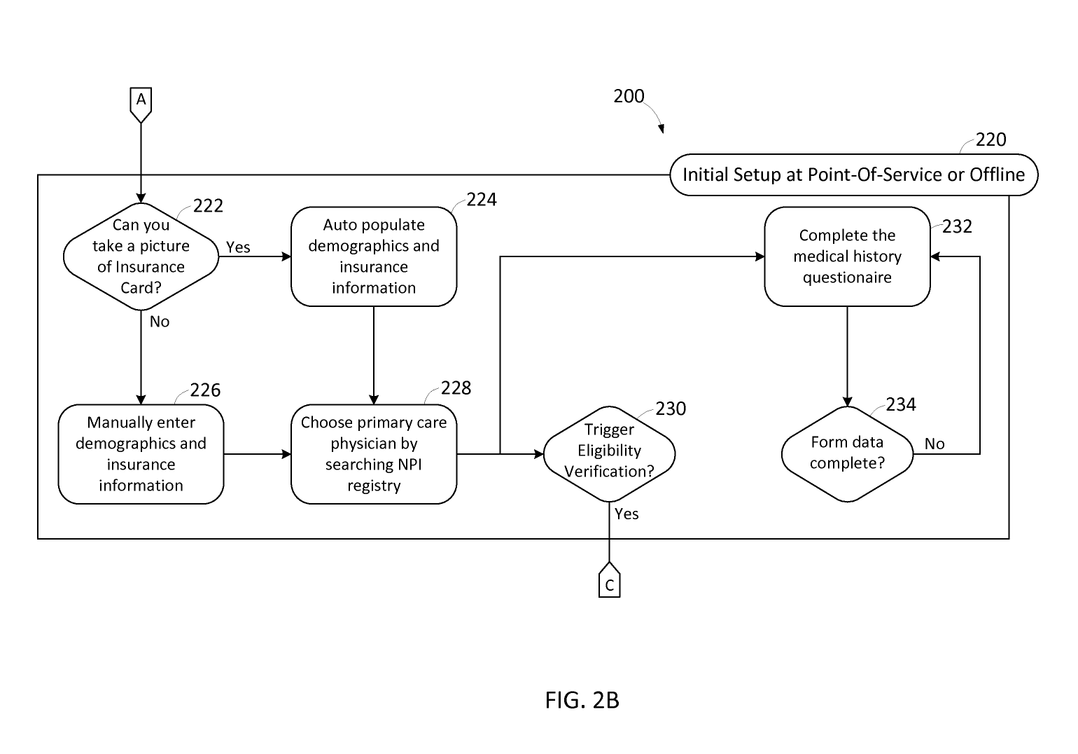

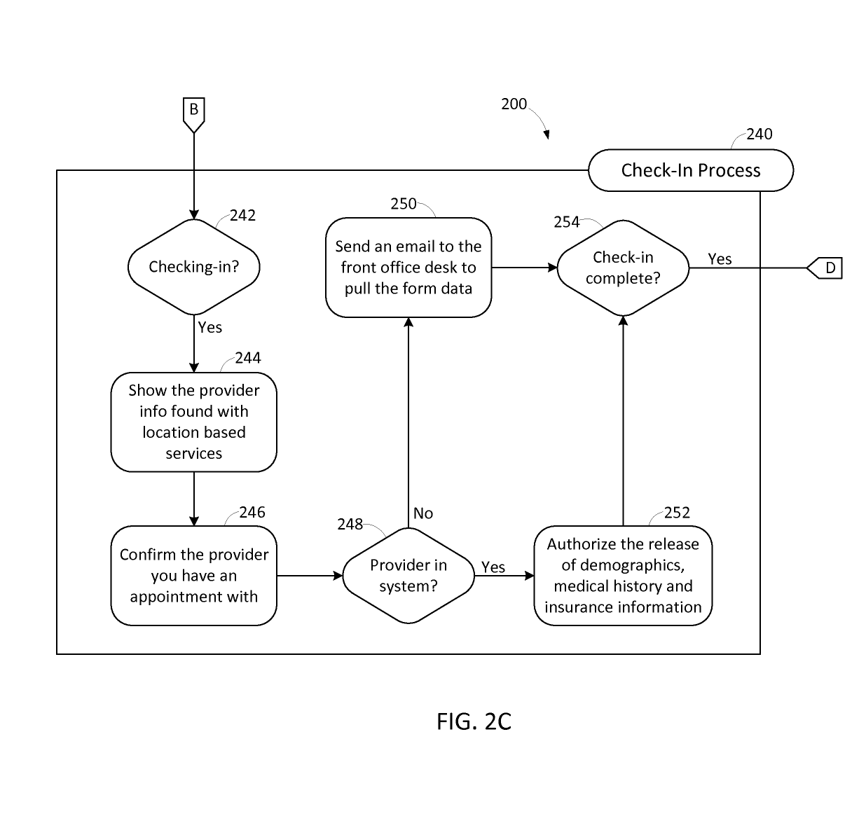

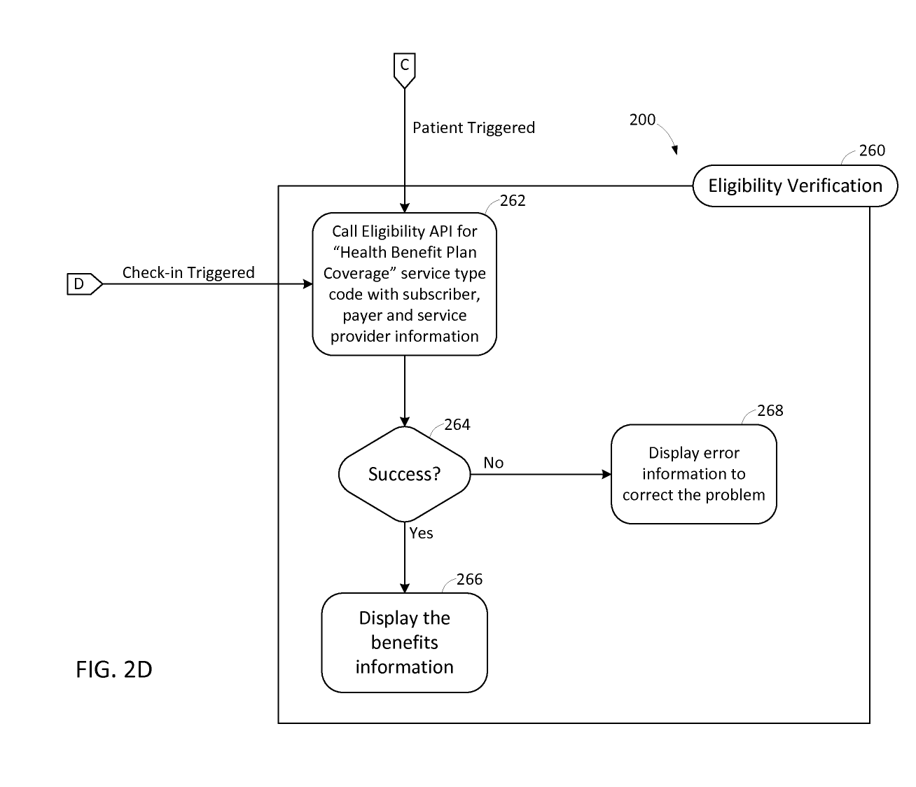

FIG. 2 is a flow diagram illustrating an example of a patient-centric process flow 200 in accordance with certain embodiments of the disclosed technology. The patient-centric process flow 200 includes four sub-aspects: authentication 202, initial setup at point-of-service or online 220, check-in process 240, and eligibility verification 260.

Within the authentication sub-aspect 202, a user first launches an application, e.g., using a smartphone, tablet, or other computing device, as shown by 204. The user may then log into the application using a username and password, for example, as shown by 206. At 208, a determination is made as to whether the login is successful: if not, the process flow returns to 206; otherwise, the process flow continues to 210, where a determination is made as to whether the user's profile has been set up or otherwise established.

If the user's profile has not been setup, the process flow shifts to the initial setup sub-aspect 220. At 222, a determination is made as to whether a picture can be taken (e.g., by the user's electronic device) of the user's [physical] insurance card: if so, the system can cause demographics and insurance information to be automatically populated, as shown at 224; otherwise, the demographics and insurance information must be manually entered, as shown at 226. The process flow then advances to 228, where the user's primary care physician or other medical provider is selected based on a search of an NPI registry.

At 230, a determination is made as to whether eligibility verification has been triggered: if so, the process flow moves into the eligibility verification sub-aspect 260, which is described in detail below. Concurrently, at 232, the medical history questionnaire is completed, either manually or automatically. A determination is made at 234 as to whether the form data is complete: if not, the process flow returns to 232 and continues to return to 232 until the form data is complete.

If the determination at 210 is that the user's profile has been set up, a determination is then made at 242 as to whether the user is checking in (e.g., at his or her medical provider's office): if so, the provider can be shown information that was found by way of location-based services, as shown at 244. At 246, the system can confirm the medical provider with whom the user has an appointment.

At 248, a determination is made as to whether the identified medical provider has a corresponding entry within the system: if so, the release of demographics, medical history, and insurance information can be authorized, as shown at 252; otherwise, the process flow moves to 250, where an email (or other suitable communication) can be sent to the front office desk [of the provider's office] to pull the form data. A determination is then made at 254 as to whether the check-in is complete and, assuming that it is, the process flow advances to the eligibility sub-aspect 260.

Within the eligibility verification sub-aspect 260, an eligibility API is called for certain benefits information, as shown at 262. The benefits information can include, but is not limited to, service type codes and service provider information. At 264, a determination is made as to whether operation of the API called at 262 has been successful: if so, the system can cause the device to display the benefits information (e.g., by way of the user's smartphone or other mobile electronic device), as shown at 266; otherwise, error information can be displayed (e.g., by way of the user's smartphone or other mobile electronic device) so as to allow the user, provider, or someone else to correct any problem(s), as shown at 268.

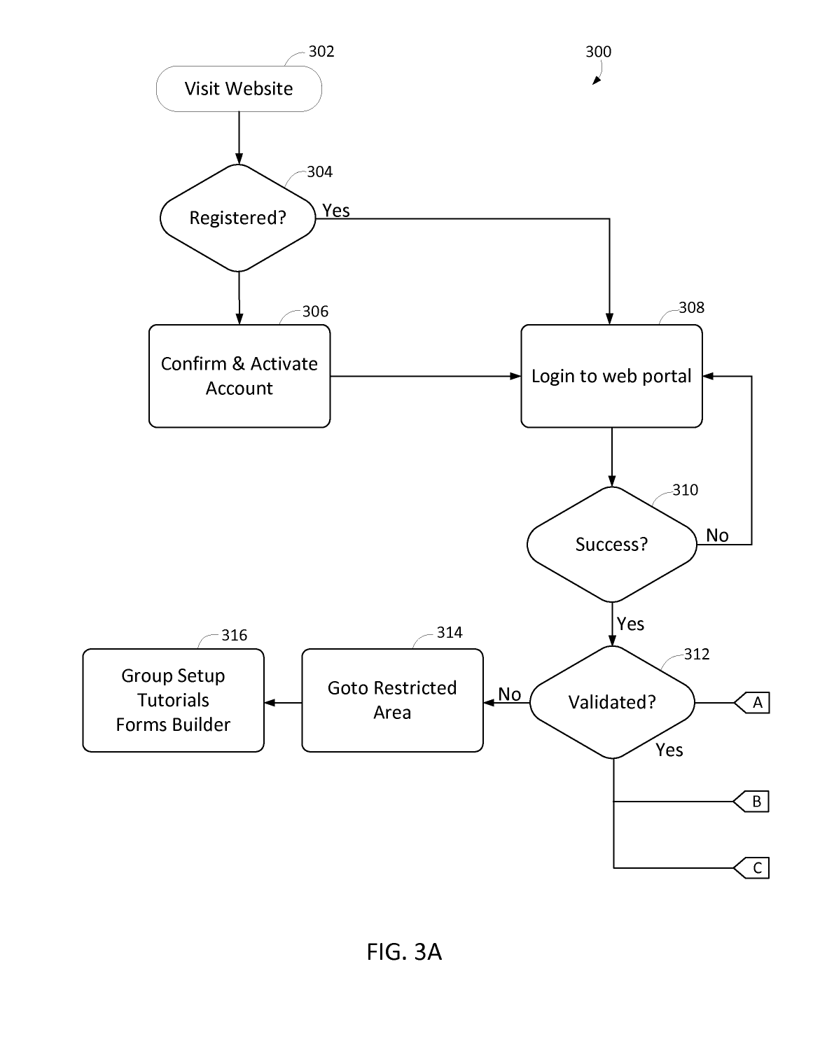

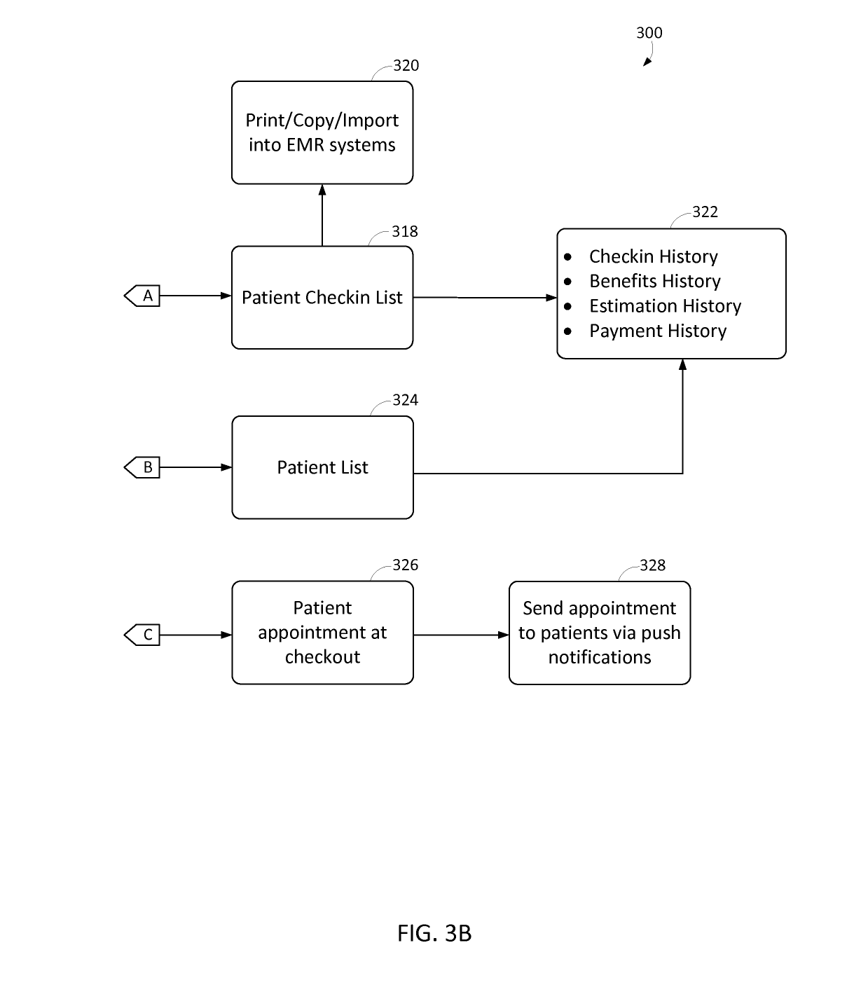

FIG. 3 is a flow diagram illustrating an example of a provider-centric process flow 300 in accordance with certain embodiments of the disclosed technology. At 302, the user visits the system website (e.g., via a home computer or a mobile electronic device such as a smartphone). At 304, a determination is made as to whether the user has already registered his or her account: if not, the user's account can be confirmed and activated, as shown by 306. At 308, the user can log into the system's web portal (e.g., using a username and password specific to the user). At 310, a determination is made as to whether the user's login attempt was successful: if not, the process flow returns to 308; otherwise, a determination is made at 312 as to whether the user account has been validated: if not, the user is directed to a restricted area (see 314) and then a group setup tutorials form builder (see 316).

At 318 and 324, respectively, the patient check-in list and patient list can be accessed and, at 322, the patient's check-in history, benefits history, estimation history, and payment history may be provided to the provider or otherwise accessed by the provider. At 326, the patient can schedule a future appointment, e.g., during the checkout process at the conclusion of the present appointment. At 328, an appointment (e.g., reminder) can be sent to the patient by way of one or more push notifications (e.g., through the user's account to the user's smartphone or other electronic device).

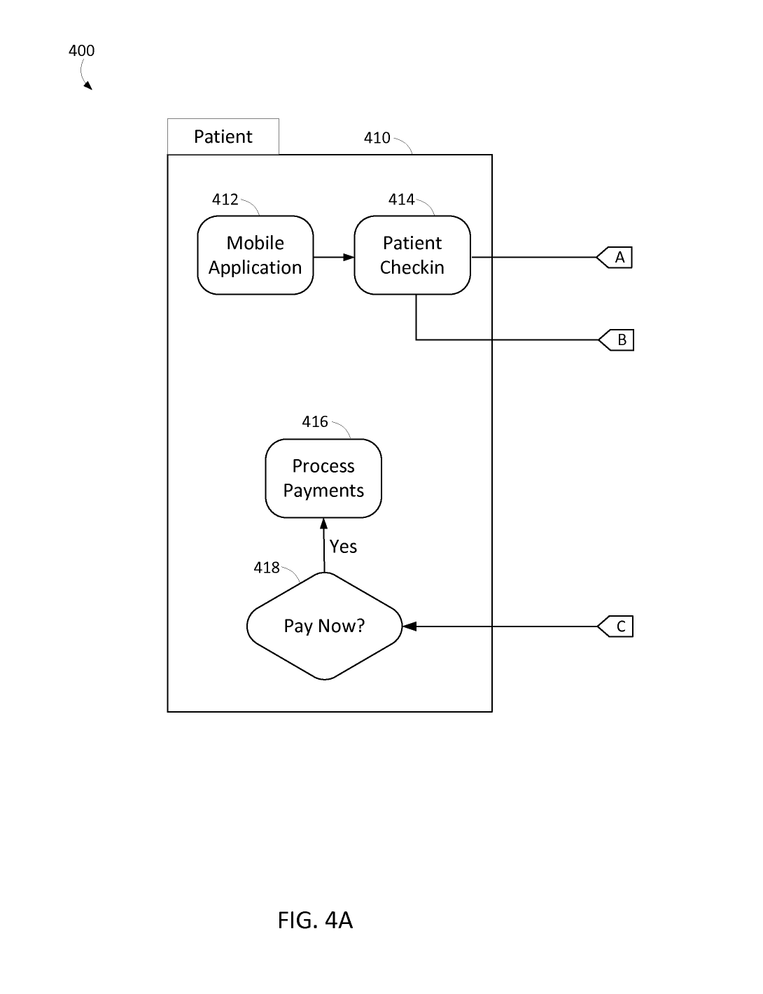

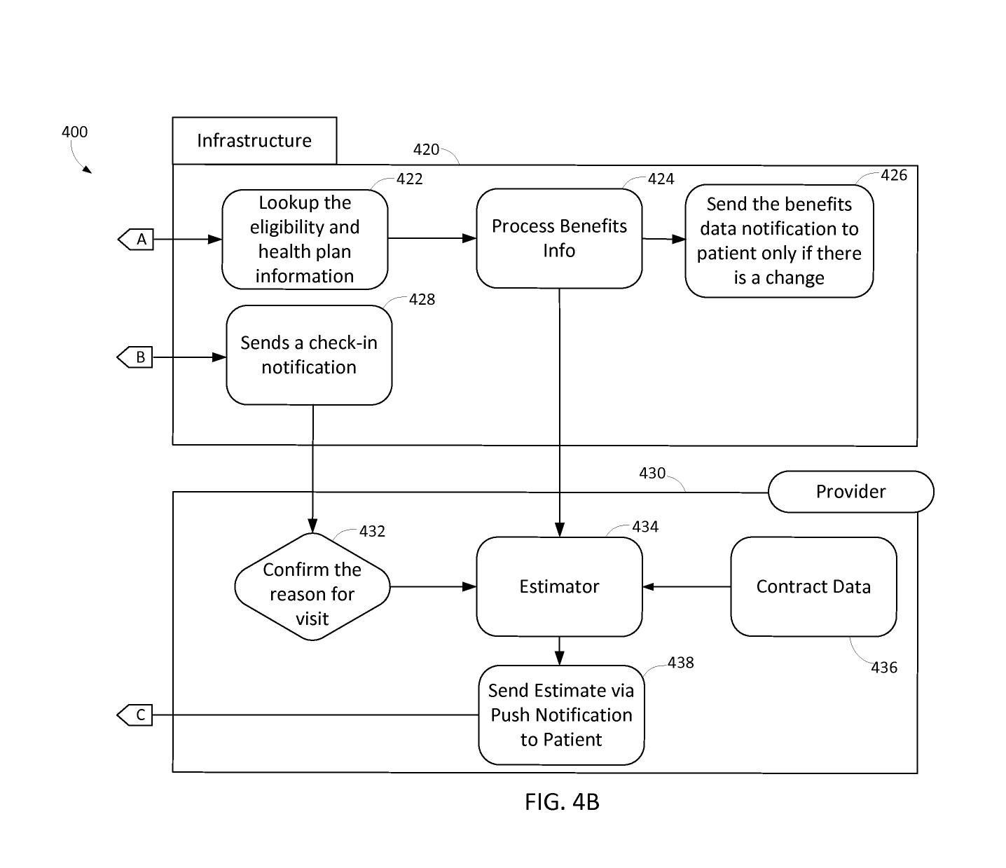

FIG. 4 is a flow diagram illustrating an example of an estimator-centric process flow 400 in accordance with certain embodiments of the disclosed technology. In the example, the estimator-centric process flow 400 includes a patient sub-aspect 410, an infrastructure sub-aspect 420, and a provider sub-aspect 430.

Within the patient sub-aspect 410, the user can launch the mobile application (e.g., using his or her smartphone or other mobile electronic device), as shown at 412. The user can then use the application to check in [for an appointment], as shown at 414. The process then moves to the infrastructure sub-aspect 420, where the patient's eligibility and health plan information can be retrieved, as shown at 422. The patient's benefits information can then be processed, as shown at 424, and, in certain embodiments (e.g., when there is a change to the benefits information), a benefits data notification can be sent to the client, as shown at 426.

A check-in notification can be sent, as shown at 428, causing the process to shift into the provider sub-aspect 430. At 432, an operation can be performed (e.g., by the user's mobile device) to confirm the patient's reason for the visit. An estimator 434 can be used to incorporate insurance-specific reimbursement schedules to calculate the anticipated cost of the visit and, in certain embodiments, how the patient's insurance company will likely adjudicate the corresponding claim. The estimator may pull contract data, as shown at 436, in forming the estimate for the patient's visit.

The estimate can then be sent directly to the patient's application (e.g., on his or her mobile device), as shown at 438. The estimate may include a breakdown of benefits and responsibilities. At 418, a determination is made (e.g., by querying the patient) as to whether the patient wishes to pay now and, responsive to the patient responding in the affirmative, payment may be processed, as shown at 416.

Payments can be processed, as shown by 416, and a determination can be made as to whether payment is due at the time of service, as shown at 418.

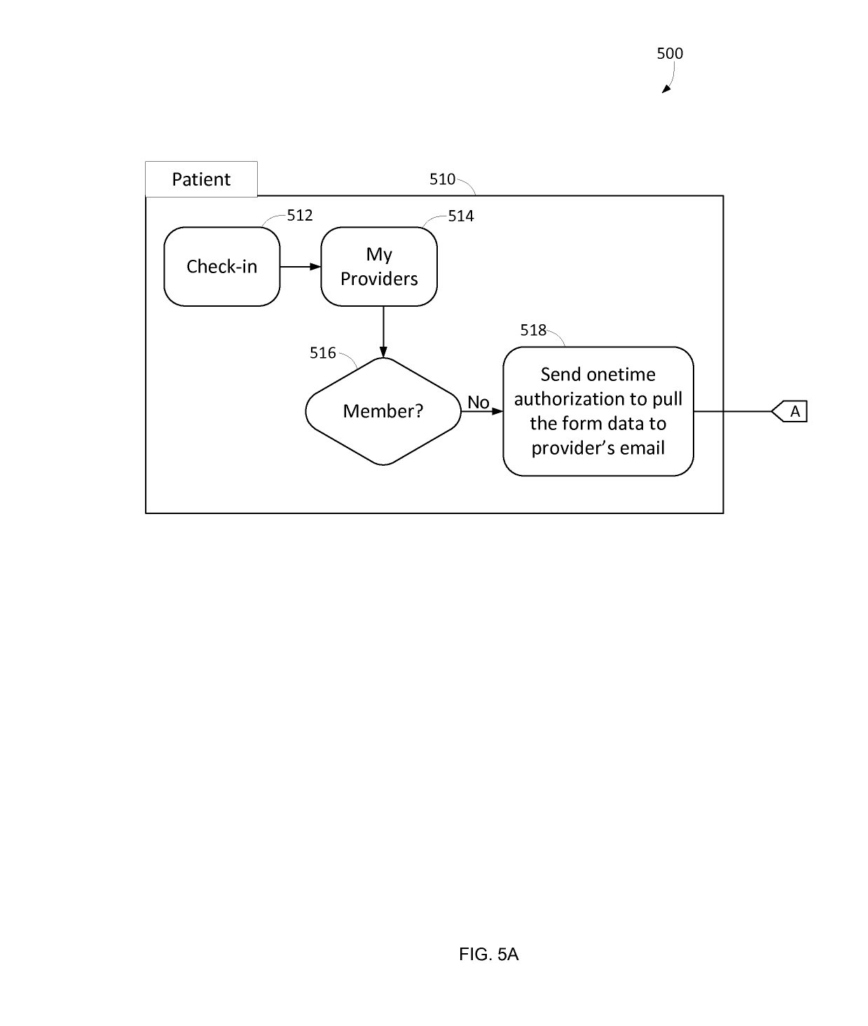

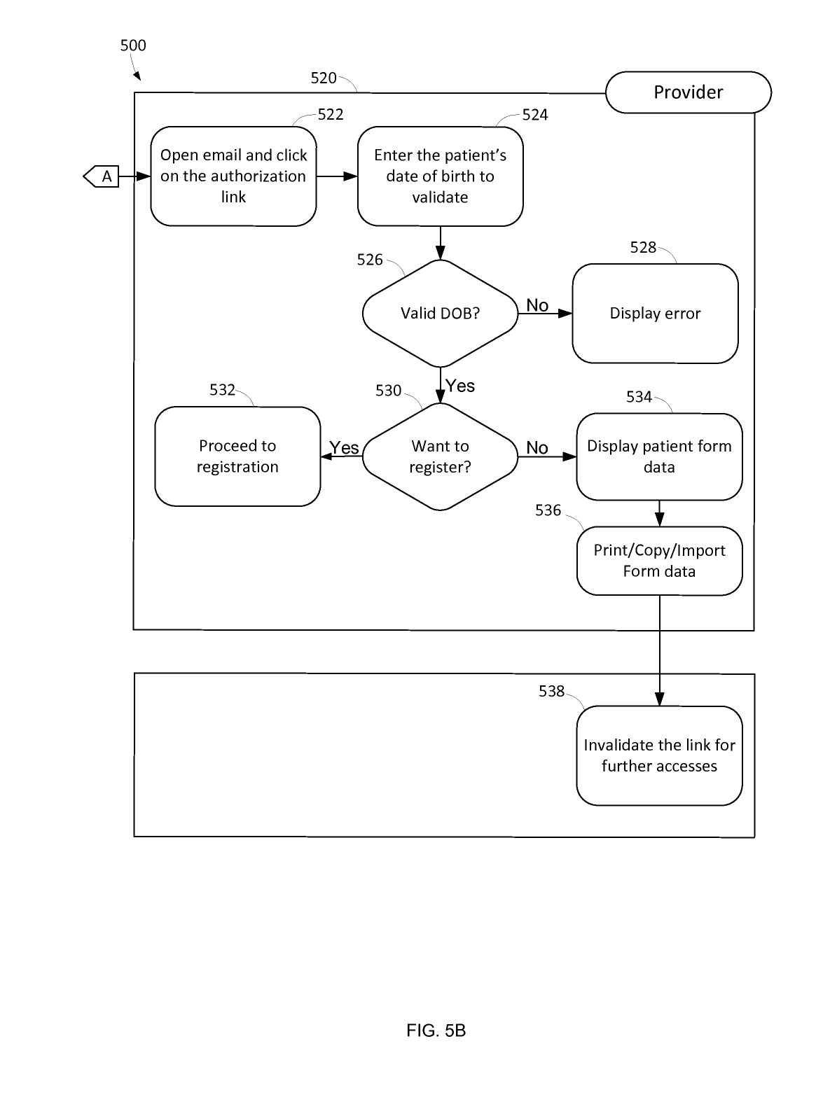

FIG. 5 is a flowchart illustrating an example of a one-time authorization process flow 500 in accordance with certain embodiments of the disclosed technology. In the example, the one-time authorization process flow 500 includes a patient sub-aspect 510 and a provider sub-aspect 520. At 512, the user can check in, e.g., using his or her smartphone or other electronic device. At 514, the user is directed to his or her My Providers section to do a provider lookup, e.g., to add providers to their account. Provider-specific communications can be maintained in this section, including scheduled follow-up appointments.

At 516, a determination is made as to whether the user is a member and, if the determination is that the user is not a member, a one-time authorization can be sent to the provider sub-aspect 520 to pull the form data to the provider's email, as shown at 518. At 522, the provider can open the email sent at 518 and click on the authorization link provided therein. The provider may then be prompted to enter the patient's date of birth for validation purposes, as shown at 524. A determination is made at 526 as to whether the entered birthdate is valid: if the determination is that the entered birthday is not valid, an error may be displayed, as shown at 528; otherwise, a determination is made (see 530) as to whether registration is desired.

If the determination at 530 is that registration is indeed desired, the process may proceed to the registration process, as shown at 532; otherwise, the patient form data may be displayed, as shown at 534, the provider can print, copy, and/or import the form data, as shown at 536, and then, in certain embodiments, the link may be invalidated (e.g., for future accesses), as shown at 538.

The following discussion is intended to provide a brief, general description of a suitable machine in which embodiments of the disclosed technology can be implemented. As used herein, the term “machine” is intended to broadly encompass a single machine or a system of communicatively coupled machines or devices operating together. Exemplary machines can include computing devices such as personal computers, workstations, servers, portable computers, handheld devices, tablet devices, communications devices such as cellular phones and smart phones, and the like. These machines may be implemented as part of a cloud computing arrangement.

Typically, a machine includes a system bus to which processors, memory (e.g., random access memory (RAM), read-only memory (ROM), and other state-preserving medium), storage devices, a video interface, and input/output interface ports can be attached. The machine can also include embedded controllers such as programmable or non-programmable logic devices or arrays, Application Specific Integrated Circuits, embedded computers, smart cards, and the like.

The machine can be controlled, at least in part, by input from conventional input devices, e.g., keyboards, touch screens, mice, and audio devices such as a microphone, as well as by directives received from another machine, interaction with a virtual reality (VR) environment, biometric feedback, or other input signal.

The machine can utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication can utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology can be described by reference to or in conjunction with associated data including functions, procedures, data structures, application programs, instructions, etc. that, when accessed by a machine, can result in the machine performing tasks or defining abstract data types or low-level hardware contexts. Associated data can be stored in, for example, volatile and/or non-volatile memory (e.g., RAM and ROM) or in other storage devices and their associated storage media, which can include hard-drives, floppy-disks, optical storage, tapes, flash memory, memory sticks, digital video disks, biological storage, and other tangible, non-transitory physical storage media. Certain outputs may be in any of a number of different output types such as audio or text-to-speech, for example.

Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A machine-controlled method, comprising:
a mobile electronic device capturing an image of a physical health insurance card for a healthcare plan for a user;
the mobile electronic device retrieving health insurance information corresponding to the healthcare plan for the user; and
a datastore storing a virtual health insurance card for the user, the virtual health insurance card including the health insurance information.

2. The machine-controlled method of claim 1, further comprising the user checking in to an appointment with a healthcare provider using the mobile electronic device.

3. The machine-controlled method of claim 2, wherein the user checking in to the appointment includes the mobile electronic device displaying to the user provider information pertaining to the healthcare provider.

4. The machine-controlled method of claim 2, wherein the user checking in to the appointment includes the mobile electronic device confirming the user's appointment with the healthcare provider.

5. The machine-controlled method of claim 2, further comprising confirming whether the healthcare provider is in the system.

6. The machine-controlled method of claim 5, further comprising, responsive to a determination that the healthcare provider is in the system, the mobile electronic device authorizing the release of at least some of the health insurance information to the healthcare provider.

7. The machine-controlled method of claim 5, further comprising, responsive to a determination that the healthcare provider is not in the system, the mobile electronic device sending a message to the healthcare provider requesting provider information pertaining to the healthcare provider.

8. The machine-controlled method of claim 2, further comprising the mobile electronic device calling an eligibility application programming interface (API) for obtaining benefits information pertaining to the healthcare plan for the user.

9. The machine-controlled method of claim 8, further comprising, responsive to a determination that calling the eligibility API was successful, the mobile electronic device displaying at least some of the benefits information.

10. The machine-controlled method of claim 8, further comprising, responsive to a determination that calling the eligibility API was not successful, the mobile electronic device displaying error information.

11. The machine-controlled method of claim 1, further comprising the user activating an account corresponding to the virtual health insurance card.

12. The machine-controlled method of claim 11, further comprising the user logging in to a web portal to access the account.

13. The machine-controlled method of claim 12, further comprising the user validating the account.

14. The machine-controlled method of claim 13, further comprising the user accessing the account.

15. The machine-controlled method of claim 14, wherein the user accessing the account comprises the user accessing at least one of the following:
check-in history,
benefits history,
estimation history, and
payment history.

16. The machine-controlled method of claim 1, further comprising the user making or otherwise authorizing a payment to the healthcare provider using the mobile electronic device.

17. The machine-controlled method of claim 17, further comprising the mobile electronic device processing the payment.

18. The machine-controlled method of claim 1, wherein the mobile electronic device is a smartphone.

19. The machine-controlled method of claim 1, wherein the mobile electronic device is a tablet computing device.

20. One or more non-transitory machine-readable storage media configured to store machine-executable instructions that, when executed by a processor, cause the processor to perform the machine-controlled method of claim 1.
